(19) United States
(12) Patent Application Publication
(10) Pub. No.: US 2004/0261599 A1
(43) Pub. Date: Dec. 30, 2004

(54) Tone control apparatus for guitars

(76) Inventor: Christopher N. Templeton, Middlebury, VT (US)

Correspondence Address: FISH & RICHARDSON PC, 225 FRANKLIN ST, BOSTON, MA, 02110, US

(21) Appl. No.: 10/871,910

(22) Filed: Jun. 18, 2004

Related U.S. Application Data
(60) Provisional application No. 60/482,256, filed on Jun. 25, 2003.

(51) Int. Cl. G10D 3/00

(52) U.S. Cl. 84/313

(57) ABSTRACT

An apparatus for selectively adjusting tone of guitar strings during play includes a base plate defining a foot surface, at least one pedal positioned at a front region of the foot surface and disposed for actuation by vertical movement of a user's foot, and at least one level positioned at a rear region of the foot surface, slidably engaged with the base plate, and disposed for actuation by horizontal movement of the heel of the user's foot. The pedal and lever are attached to the bridge of the guitar by cables. Movement of the pedal or lever causes tension of individual guitar strings to be adjusted.

This application claims benefit from U.S. Provisional Application No. 60/482,256, filed Jun. 25, 2003, now abandoned.

The invention relates to a tone control apparatus for string instruments, and more particularly to guitars.

### TECHNICAL FIELD

### BACKGROUND

Typically, as a guitar is being played, the musician changes the tone of individual strings of the guitar by pressing the strings against the neck of the guitar with his or her fingers. It is also known to affect changes in the tone of the guitar beyond those the musician can produce by hand. For example, mechanisms operated by the musician's foot are used to selectively increase or decrease tension in the guitar strings.

### SUMMARY

In general, according to one aspect of the invention, an apparatus for selectively adjusting tone of guitar strings during play includes a base plate defining a foot surface, a pedal positioned at a front region of the foot surface and disposed for actuation by vertical movement of a user's foot, and a lever positioned at a rear region of the foot surface, slidably engaged with the base. plate, and disposed for actuation by horizontal movement of the heal of the user's foot. The pedal is attached to the bridge of the guitar by a first cable, and the lever is attached to the bridge of the guitar by a second cable. Movement of the pedal and lever causes tension of individual strings of the guitar to be adjusted.

Embodiments of this aspect of the invention may include one or more of the following additional features. A second pedal is positioned adjacent to the first mentioned pedal at the front region of the foot surface and disposed for actuation by vertical movement of the user's foot. The second pedal is attached to the bridge of the guitar by a third cable, and movement of the second pedal causes tension of the individual strings of the guitar to be adjusted. A second lever is positioned at the rear region of the foot surface, slidably engaged with the base plate, and disposed for actuation by horizontal movement of the heal of the user's foot. The second lever is attached to the bridge of the guitar by a fourth cable. The two levers are positioned so that the user's foot is located between the levers while the guitar is being played. Movement of the second lever causes the tension of the individual strings of the guitar to be adjusted. Each of the cables includes an outer sheath and an inner wire coaxially and slidably disposed within the sheath.

According to another aspect of the invention, an apparatus for selectively adjusting tone of guitar strings during play includes a base plate defining a foot surface, a first pedal and a second pedal positioned adjacent to the first pedal where both pedals are positioned at a front region of the foot surface and disposed for actuation by vertical movement of a user's foot, a first lever and a second lever positioned at a rear region of the foot surface, slidably engaged with the base plate, and disposed for actuation by horizontal movement of the heal of the user's foot. Each pedal and lever is attached to the bridge of a guitar by a respective cable. The two levers are positioned so that the user's foot is located between the levers while the guitar is being played. Movement of the pedals and the levers causes the tension of the individual strings of the guitar to be adjusted.

Embodiments of this aspect of the invention may include the following additional features. The apparatus includes the cables. Each of the cables may include an outer sheath and an inner, wire slidably and coaxially disposed within the sheath.

Among other advantages, the tone control apparatus of the present invention provides the musician multiple degrees of control to affect tone changes of the guitar by movement of the foot in place. Thus the musician is able to produce additional tone changes with his or her foot while simultaneously playing the guitar.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a perspective view of a foot control device of the invention.

FIG. 2 is a sectional view taken along the line 2-2 of FIG. 1.

FIG. 3 is a sectional view taken along the line 3-3 of FIG. 2; and

FIG. 4 is a sectional view taken along the line 4-4 of FIG. 1.

Like reference symbols in the various drawings indicate like elements.

### DETAILED DESCRIPTION

A foot control device of the invention is constructed for use in combination with an instrument such as a steel guitar. The tone of the guitar strings is changed by manipulating the foot control device.

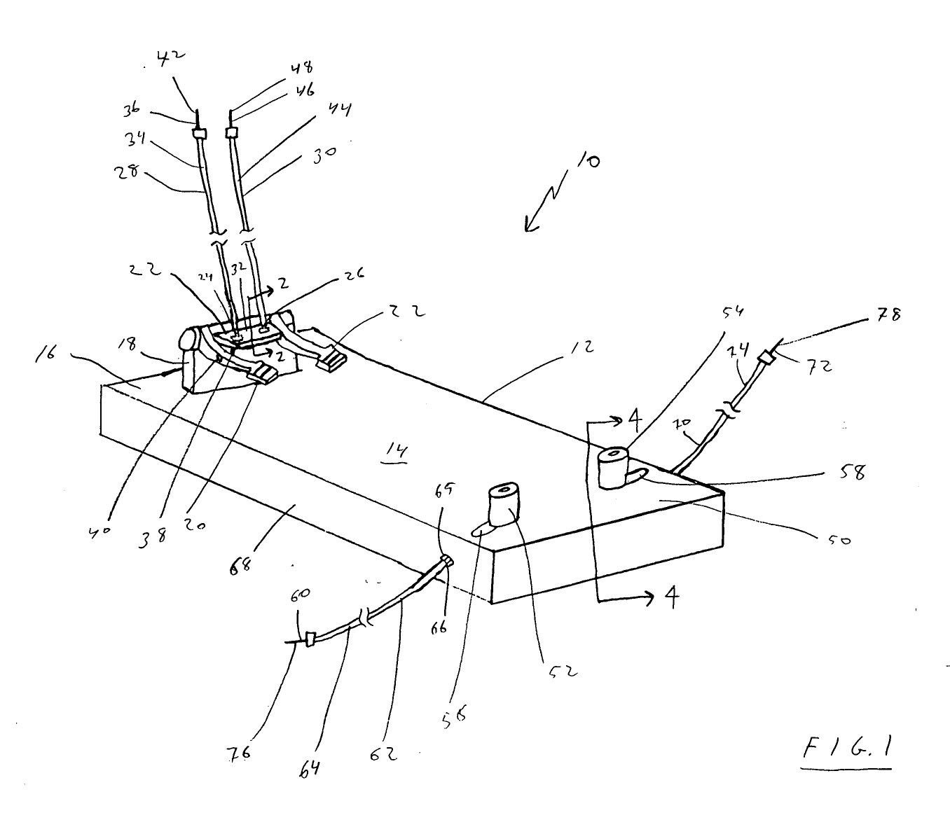

Referring to FIG. 1, a foot control device 10 has a base 12 defining a foot surface 14. At a front region 16 of foot surface 14, a vertically extending plate 18 is rigidly affixed to base 12. Pedals 20 and 22 are pivotally connected to plate 18 by a transversely extending shaft 20 (FIG. 2).

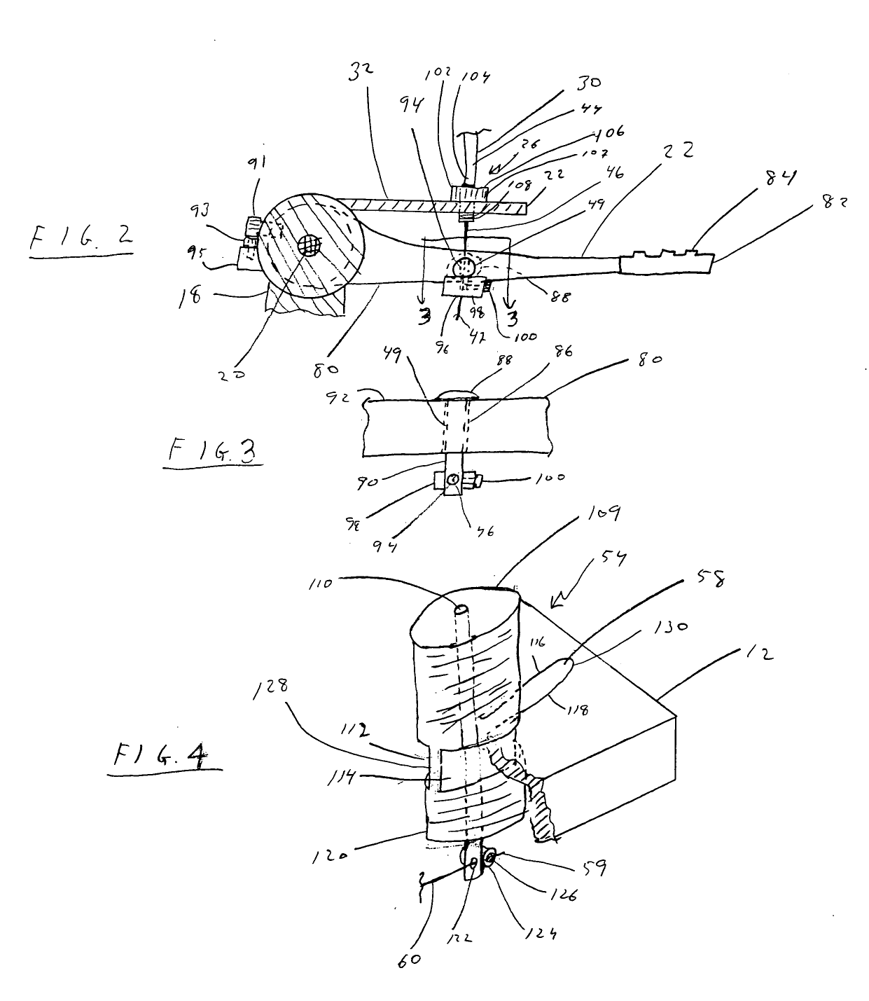

A horizontally extending stop plate 22 is attached to the top of plate 18 and extends towards the rear of foot control device 10. Proximal ends 24, 26 of a respective first cable 28 and a second cable 30 abut against a top surface 32 of stop plate 22. First cable 28 consists of a sheath 34, and a wire 36 slidably disposed within sheath 34. Wire 36 has a first end 38 connected to a bolt 40 held by pedal 20. Second cable 30 also consists of a sheath 44 and a wire 46 slidably disposed within sheath 44. Similar to wire 36, wire 46 has a first end 47 (FIG. 2) attached to a bolt 49 held by pedal 22. Details of the connection between first end 47 and bolt 49 are described in detail below with reference to FIGS. 2 and 3. A second end 42 of wire 36 and a second end 48 of wire 46 are attached to a bridge of the steel guitar.

At opposite sides of a rear region 50 of the foot surface 14 are positioned a pair of levers 52 and 54. Levers 52 and 54 are disposed in base 14 for sliding movement along slots 56 and 58, respectively, defined by base 14. Lever 54 is connected to a first end 59 (FIG. 4) of a wire 60 of a cable 62 that also includes a sheath 64 coaxially disposed about wire 60. An adjusting screw 65 at a first end 66 of sheath 64 is threaded into a side 68 of base 12. Wire 62 slides within sheath 64 as lever 54 is moved along slot 58. Similarly, cable 70 consists of a wire 72 slidably disposed within a sheath 74. Wire 72 has a first end (not shown) attached to lever 52. Respective second ends 76, 78 of wires 60 and 72 are also attached to the bridge of the guitar.

Referring to FIGS. 2 and 3, pedal 22 has an arm 80 pivotally mounted on shaft 20 and a flattened enlarged end 82 attached to the end of arms 80 distal to shaft 20. Enlarged end 82 defines ridges 84 to enhance traction between the user's foot and enlarged end 82. Bolt 49 extends transversely through a bore 86 defined by arm 80. Bolt 49 has an enlarged head 88 on a shank 90. The diameter of enlarged head 88 is larger than the diameter of bore 86 so that enlarged head 88 abuts against outer surface 92 of arm 80 to restrict bolt 49 from sliding through bore 86. The first end 47 of wire 46 passes through hole 94 defined in shank 90 and through hole 96 defined in nut 98, to be secured to nut 98 by threaded screw 100.

Screw 91 slidably engages with an end of arm 80 proximal to shaft 20. Another screw 93 is threaded into stop block 95 attached to plate 18. As pedal 22 is rotated upwards about shaft 20, screw 91 abuts against screw 93 to restrict pedal 22 from further rotation.

Adjusting screw 102 is located at proximal end 26 of cable 30. Wire 46 passes through a central hole (not shown) of adjusting screw 102, and proximal end 104 of sheath 44 abuts against surface 106 of enlarged head 107 of adjusting screw 102. Adjusting screw 102 has a threaded shank 108 screwed into stop plate 22.

Adjusting screw 102 is rotated to cause pedal 22 to rotate upward until screw 91 abuts against screw 93. Further rotation of adjusting screw 102 increases tension in wire 46 to a desired amount. The description of pedal 20 and the connection between pedal 20 and wire 36 is similar to the foregoing description with reference to FIGS. 2 and 3.

Referring to FIG. 4, lever 54 includes body 109 mounted on shaft 110. Body 109 defines two grooves 112 and 114 that receive opposed sides 116 and 118 of slot 58. Shaft 110, extending from bottom 120 of body 109, defines hole 122 located beneath bottom 120. First end 59 of wire 60 is placed through hole 122 and secured to nut 124 by screw 126. Adjusting screw 65 (FIG. 1) is rotated to cause edge 128 of body 109 to abut against an adjustable stop (not shown) positioned distal from end 130 of slot 58. Tension in wire 60 may be further increased by appropriately rotating adjusting screw 65. The description and operation of lever 52 is similar to that for lever 54 discussed with reference to FIG. 4.

In use, a musician places his or her foot on foot surface 14, with the heel of the foot located between lever 52, 54 and the toes of the foot positioned near pedals 20, 22. As tile musician plays the guitar, pedals 20, 22 are actuated by vertical movement of the musician's toes and levers 52, 54 are actuated by horizontal movement of the musician's heel. Movement of pedals 20, 22 and levers 52, 54 selectively causes tensioning of the respective wires connected to the pedals and levers to be increased or decreased, which correspondingly causes the tone of individual strings of the guitar to rise or fall, thereby changing the tone of the guitar string as they are being played.

As described above, the foot control device of the invention is used in combination with a guitar. However, the foot control device can be used in other fields, for example, electronic communications, aviation and machine control.

A number of embodiments of the invention have been described. Nevertheless, it will be understood that various modifications can be made without departing from the spirit and scope of the invention. Accordingly, other embodiments are within the scope of the following claims.

What is claimed is:

1. An apparatus for selectively adjusting tone of guitar strings during playing, said apparatus comprising
a base plate defining a foot surface,
at least a first pedal positioned at a front region of the foot surface and disposed for actuation by vertical movement of a user's foot, said first pedal being attached to the bridge of the guitar by a first cable, and
at least a first lever positioned at a rear region of the foot surface, slidably engaged with the base plate, and disposed for actuation by horizontal movement of the heel of the user's foot, said first lever being attached to the bridge of the guitar by a second cable,
wherein movement of the pedal and lever causes tension of individual guitar strings to be adjusted.

2. The apparatus of claim 1 further comprising a second pedal positioned adjacent to the first pedal at the front region of the foot surface and disposed for actuation by vertical movement of the user's foot, said second pedal being attached to the bridge of the guitar by a third cable, wherein movement of the second pedal causes tension of individual guitar strings to be adjusted.

3. The apparatus of claim 1 further comprising a second lever positioned at the rear region of the foot surface, slidably engaged with the base plate, and disposed for actuation by horizontal movement of the heel of the user's foot, said second lever being attached to the bridge of the guitar by a third cable, said first lever and said second lever being positioned so that the user's foot is located between the first lever and the second lever while the guitar is being played, wherein movement of the second lever causes tension of individual guitar strings to be adjusted.

4. The apparatus of claim 1 further comprising said first cable.

5. The apparatus of claim 4 wherein said first cable comprises an outer sheath and an inner wire coaxially and slidably disposed within said outer sheath.

6. The apparatus of claim 1 further comprising said second cable.

7. The apparatus of claim 6 wherein said second cable comprises an outer sheath and an inner wire coaxially and slidably disposed within said outer sheath.

8. The apparatus of claim 1 further comprising a second pedal positioned adjacent to the first pedal at the front region of the foot surface and disposed for actuation by vertical movement of the user's foot, said second pedal being attached to the bridge of the guitar by a third cable, and a second lever positioned at the rear region of the foot surface, slidably engaged with the base plate, and disposed for actuation by horizontal movement of the heel of the user's foot, said lever being attached to the bridge of the guitar by a fourth cable, said first lever and said second lever being positioned so that the user's foot is located between the first lever and the second lever while the guitar is being played, wherein movement of the second pedal and the second lever causes tension of individual guitar strings to be adjusted.

9. The apparatus of claim 8 further comprising said first, second, third and fourth cables.

10. The apparatus of claim 9 wherein each of said first, second, third and fourth cables comprises an outer sheath and an inner wire slidably and coaxially disposed within the outer sheath.

11. An apparatus for selectively adjusting tone of guitar strings during play, said apparatus comprising
a base plate defining a foot surface,
a first pedal positioned at a front region of the foot surface and disposed for actuation by vertical movement of a user's foot, said pedal being attached to the bridge of the guitar by a first cable,
a second pedal positioned adjacent to the first pedal at the front region of the foot surface and disposed for actuation by vertical movement of the user's foot, said second pedal being attached to the bridge of the guitar by a second cable,
a first lever positioned at a rear region of the foot surface, slidably engaged with the base plate, and disposed for actuation by horizontal movement of the heel of the user's foot, said lever being attached to the bridge of the guitar by a third cable, and
a second lever positioned at the rear region of the foot surface, slidably engaged with the base plate, and disposed for actuation by horizontal movement of the heel of the user's foot, said second lever being attached to the bridge of the guitar by a fourth cable, said first lever and said second lever being positioned so that the user's foot is located between the first lever and the second lever while the guitar is being played, wherein movement of the first and second pedals and the first and second levers causes tension of individual guitar strings to be adjusted.

12. The apparatus of claim 11 further comprising said first, second, third and fourth cables.

13. The apparatus of claim 12 wherein each of said first, second, third and fourth cables includes an outer sheath and an inner wire slidably and coaxially disposed within the outer sheath.
